(19) United States
(12) Patent Application Publication
(10) Pub. No.: US 2020/0231047 A1
(43) Pub. Date: Jul. 23, 2020

(54) DRIVE SYSTEM FOR ELECTRICALLY-DRIVEN AIRCRAFT

(71) Applicant: H55 SA, Sion (CH)

(72) Inventor: Sébastien Demont, Les Agettes (CH)

(21) Appl. No.: 16/796,711

(22) Filed: Feb. 20, 2020

Related U.S. Application Data
(63) Continuation-in-part of application No. PCT/IB2020/050520, filed on Jan. 23, 2020.

(30) Foreign Application Priority Data
Jan. 23, 2019 (CH) 20190000073

(51) Int. Cl. B60L 15/20; B64D 27/24; H02P 6/16; H02P 29/028

(52) U.S. Cl. CPC B60L 15/20; B64D 27/24; B60L 2200/10; H02P 29/028; H02P 6/16

(57) ABSTRACT

A drive system for an electrically-driven aircraft can include a first motor controller and a second motor controller. The first motor controller can control a motor to propel a vehicle housing. The first motor controller can control the motor using a parameter measured with a sensor that is configured to monitor a motor system component. The second motor controller can control the motor in place of the first motor controller to propel the vehicle housing. The second motor controller can control the motor without using a physical position and a change in the physical position of any motor system component measured with any sensor.

### RELATED APPLICATIONS

Any and all applications for which a foreign or domestic priority claim is identified in the Application Data Sheet of the present application are hereby incorporated by reference under 37 CFR 1.57.

### FIELD

The present disclosure concerns an electrical powering or drive system for a motor in an electrically driven aircraft.

### BACKGROUND

Electric and hybrid vehicles have become increasingly significant for the transportation of people and goods. Such vehicles can desirably provide energy efficiency advantages over combustion-powered vehicles and may cause less air pollution than combustion-powered vehicles during operation.

Although the technology for electric and hybrid automobiles has significantly developed in recent years, many of the innovations that enabled a transition from combustion-powered to electric-powered automobiles unfortunately do not directly apply to the development of electric or hybrid aircraft. The functionality of automobiles and the functionality of aircraft are sufficiently different in many aspects so that many of the design elements for electric and hybrid aircraft must be uniquely developed separate from those of electric and hybrid automobiles.

Flying a manned or unmanned aircraft such an airplane can be dangerous. Problems with the aircraft may result in injury or loss of life for passengers in the aircraft or individuals on the ground, as well as damage to goods being transported by the aircraft or other items around the aircraft.

Therefore, any changes to an aircraft's design, such as to enable electric or hybrid operation, also require careful development and testing to ensure safety and reliability. If an aircraft experiences a serious failure during flight, the potential loss and safety risk from the failure may be very high as the failure could cause a crash of the aircraft and pose a safety or property damage risk to passengers or cargo, as well as individuals or property on the ground.

Attempts to make electric and hybrid aircraft commercially viable have been largely unsuccessful. New approaches for making and operating electric and hybrid aircraft thus continue to be desired.

There is therefore a need for simplified, yet robust, components and systems for an electric powered aircraft that simplify and streamline certifications requirements and reduce the cost and time required to produce a commercially viable electric aircraft.

### SUMMARY

It is an aim of certain embodiments of the present disclosure to improve the electrical drive system for electrically driven aircrafts.

According to some embodiments, an electrical drive system for an electrically driven aircraft can include the following: a power source; a motor; a main motor controller using a sensor for controlling the motor based on a parameter measured with the sensor; and a redundant motor controller for controlling the motor, the redundant motor controller being sensorless.

In the present application, a motor controller may considered to be sensorless if (apart from the motor coils) it does not include any additional components for determining the position or speed of the rotor. For example, a motor controller without any position or speed encoder or sensor may considered to be sensorless, even if it may include other types of sensors.

In some embodiments, the redundant motor controller may not include any sensor of any type and may, for example, not include a position sensor, a speed sensor, or a temperature sensor.

The redundant motor controller can be a simpler controller than the main motor controller. For example, because the redundant motor controller can be sensorless, the sensor and the cable between the sensor and other electronic components may not need to be certified. Therefore, the certification of the redundant motor controller may be easier than the certification of the main motor controller. Nevertheless, the redundant motor controller can control of the motor if the main motor controller experiences a failure. Accordingly, because a redundant motor controller may be available, a failure of the main motor controller may not be critical so that less stringent certification criteria may be applied to the main motor controller. As a result, providing two motor controllers of different types can make the overall system easier to certify, without having to compromise on security.

The redundant motor controller may not use a field-oriented control. In some embodiments, the redundant motor controller may not use a sinusoidal commutation. In some embodiments, the redundant motor controller may not compute a prediction of the position of the rotor. A redundant motor controller that does not use one or any such advanced motor control schemes may be easier to certify than a motor controller which uses a field-oriented control or other methods for generating three sinusoidal waveforms based on a position of the rotor measured with sensor or predicted.

The main motor controller can use one or more sensors.

The main motor controller can measure one or more parameters.

The parameter or parameters that are measured by the sensor or sensors can be parameters of the motor.

The motor can include a rotor.

The parameter or parameters that are measured by the sensor can include the speed or position (such as, angular) of the rotor.

At least one sensor can be or include an encoder, such as a position encoder.

The redundant motor controller can include fewer components than the main motor controller. Certification of a controller with fewer components may usually be easier than certification of a controller with a greater number of components.

The redundant motor controller can be lighter weight or have a smaller volume than the main motor controller. The redundant motor controller can be designed for controlling the motor at a lower rotational speed or torque than the main motor controller.

The maximal rotation speed of the motor when controlled by the main motor controller can be higher than the maximal rotation speed of the motor when controlled by the redundant motor controller.

The maximal torque of the motor when controlled by the main motor controller can be higher than the maximal torque of the motor when controlled by the redundant motor controller.

The efficiency of the motor when controlled by the main motor controller can be higher than the efficiency of the motor when controlled by the redundant motor controller.

The redundant motor controller may be unable to control the motor to operate at as high of a speed or torque as the main motor controller. This may generally not be an issue, however, because the redundant motor controller may be used in case of a failure of the main motor controller and not when the main motor controller is correctly operating.

The motor can be a three-phase electric motor.

The motor can be a permanent magnet synchronous motor.

The main motor controller can use a closed-loop vector control method to generate three sinus signals dependent on the parameter, and one signal can be applied to each different phase. A closed-loop vector control method can allow the motor to be operated efficiently and with low energy losses.

The redundant motor controller can generate multiple non-sinusoidal signals, and each of the multiple non-sinusoidal signals can be applied to one phase. Applying non-sinusoidal signals to the different phases of a permanent magnet synchronous motor may be less efficient than applying sinusoidal signals and may increase torque ripples. Therefore, non-sinusoidal signals may not be recommended in some cases, such as in aeronautics where highly efficient motors are desired. However, generating non-sinusoidal signals with a sensorless encoder may be easier than generating sinusoidal signals because generating non-sinusoidal signals may not use complex computations for predicting the position of the rotor at each instant. As a result, the redundant motor controller can be easier to certify than the main motor controller.

The redundant motor controller can generate non-sinusoidal signals.

The redundant motor controller can generate three non-sinusoidal signals, two of each of the three non-sinusoidal signals being applied at each time to two phases of the motor.

The redundant motor controller can be arranged for using voltage induced in a first phase in order to determine the signals to apply to a second phase and a third phase. The redundant motor controller can generate stepped signals.

The redundant motor controller can generate trapezoidal signals.

In some embodiments, the motor can include a first rotor, and the electrical drive system can include: a transducer having a second rotor and drive coils; a rotor shaft, the first rotor and the second rotor being both attached to the rotor shaft; a circuit for measuring an electromotive force (EMF) induced in the drive coils of the transducer when the rotor shaft is rotated by the motor, wherein the redundant motor controller can use the electromotive force for controlling the motor.

The embodiment of the preceding paragraph can permit control of the motor by the redundant motor controller based on the position or speed of its rotor, which can be determined by the transducer and without any additional sensors.

The system can include a switch for manually activating the redundant motor controller to control the motor in place of the main motor controller. Manually can man that the transition of control of the motor from the main motor controller to the redundant motor controller can be commanded by the pilot, for example, when a signal in the cockpit indicates to the pilot a failure of the main motor controller.

The switch can connect (such as electrically) the motor either with the main motor controller or the redundant motor controller. The switch can connect the power source either with the main motor controller or the redundant motor controller.

The system can include a main motor controller monitoring system for detecting failures of the main motor controller.

The motor controller monitoring system can be distinct from the redundant motor controller. As a result, a defect in the redundant motor controller may not trigger a switch from the main motor controller to the redundant motor controller.

The main motor controller monitoring system can trigger a switch in operating the motor from the main motor controller to the redundant motor controller when a failure has been detected.

The redundant motor controller may include non-programmable components and may not include programmable components, so that a certification of the redundant motor controller may be easier.

The main motor controller can include silicon carbide components and a digital signal processor to generate drive signals.

The redundant motor controller can be more conventional than the main motor controller.

The redundant motor controller can include insulated-gate bipolar transistor (IGBT) components.

The system can include a first cooling system for dissipating heat produced by the main motor controller and a second cooling system for dissipating heat produced by the redundant motor controller.

The second cooling system can be a different type from the first cooling system, so a failure of the first cooling system may be unlikely to occur simultaneously with a failure of the second cooling system.

The system can include a liquid-based cooling system for dissipating heat produced by the main motor controller; and an air-based cooling system for dissipating heat produced by the redundant motor controller.

A drive system for an electrically-driven aircraft can include a first motor controller and a second motor controller. The first motor controller can control a motor to propel a vehicle housing. The first motor controller can control the motor using a parameter measured with a sensor that is configured to monitor a motor system component. The second motor controller can control the motor in place of the first motor controller to propel the vehicle housing. The second motor controller can control the motor without using a physical position of any motor system component measured with any sensor and without using a change in the physical position of any motor system component measured with any sensor.

The drive system of the preceding paragraph can include one or more of the following features: The motor system component monitored by the sensor can be a vehicle component that facilitates propelling of the vehicle housing by the motor. The motor system component monitored by the sensor can be the motor, a rotor of the motor, or a propeller for the motor. The parameter measured with the sensor can be a physical position of an axis of the motor, the rotor, or the propeller or a change in the physical position of the axis.

This disclosure provides at least some approaches for constructing electric powered aircraft from components and systems that have been designed to pass certification requirements so that the aircraft itself may pass certification requirements and proceed to active commercial use.

### BRIEF DESCRIPTION OF THE DRAWINGS

The present disclosure will be better understood with the aid of the description of one or more embodiments given by way of example and illustrated by the figures, in which:

FIG. 1 illustrates an aircraft, such as an electric or hybrid aircraft;

FIG. 2 illustrates a simplified block diagram of an aircraft;

FIG. 3 illustrates the components of a system for operating an aircraft;

FIG. 4 illustrate an example circuit comprising a power source, one or a plurality of motors, and motor controllers; and

FIG. 5 illustrates a simplified block diagram of a drive system of an aircraft in an embodiment with two distinct transducers.

### DETAILED DESCRIPTION

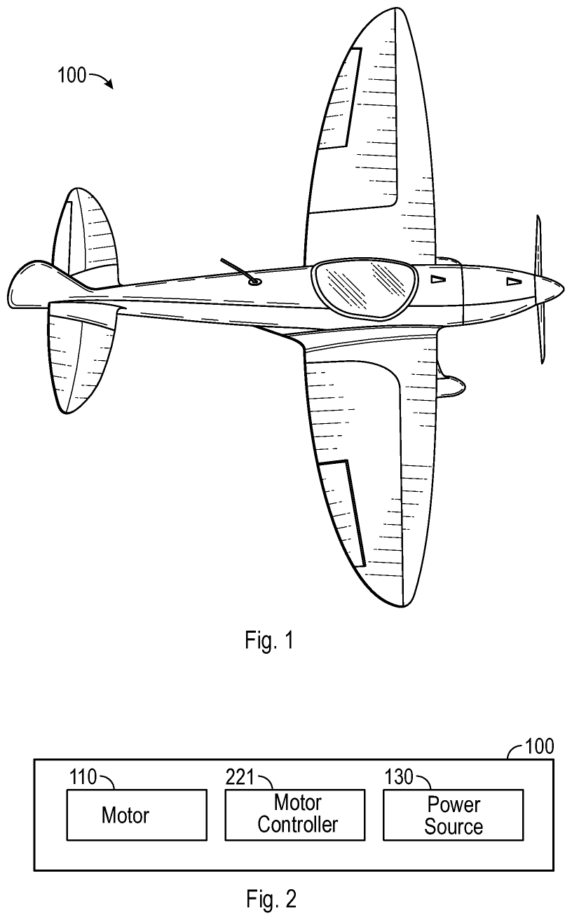

FIG. 1 illustrates an aircraft 100, such as an electric or hybrid aircraft, and FIG. 2 illustrates a simplified block diagram of the aircraft 100. The aircraft 100 can include a motor 110, a motor controller 221, and a power source 130. The aircraft 100 can include one or more components or features of aircrafts disclosed in (i) U.S. Pat. No. 10,131,246, issued Nov. 20, 2018, titled “COMMUNICATION SYSTEM FOR BATTERY MANAGEMENT SYSTEMS IN ELECTRIC OR HYBRID VEHICLES,” (ii) U.S. Pat. No. 10,322,824, issued Jun. 18, 2019, titled “CONSTRUCTION AND OPERATION OF ELECTRIC OR HYBRID AIRCRAFT,” (iii) Int'l Patent Application No. PCT/IB2019/053644, filed May 3, 2019, titled “AIRCRAFT MONITORING SYSTEM AND METHOD FOR ELECTRIC OR HYBRID AIRCRAFTS,” and (iv) Int'l Patent Application No. PCT/IB2019/055110, filed Jun. 18, 2019, titled “AIRCRAFT MONITORING SYSTEM AND METHOD FOR ELECTRIC OR HYBRID AIRCRAFTS;” the entire disclosures of which are hereby incorporated by reference.

The motor 110 can be used to propel the aircraft 100 and cause the aircraft 100 to fly and navigate. The motor controller 221 can control and monitor the motor 110. The power source 130 can power the motor 110 to drive the aircraft 100 and power the motor controller 221 to enable operations of the motor controller 221. The motor controller 221 can include multiple controllers (such as a main motor controller and a redundant motor controller), as well as other electronic circuitry for controlling and monitoring one or more components of the aircraft 100.

The power source 130 can include one or more battery packs including multiple battery cells, such as lithium-ion cells. The battery cells can be connected in series or in parallel to deliver an appropriate voltage and current.

The motor 110 can be a three-phase motor, such as a brushless motor or a permanent magnet synchronous motor, which may be connected via a three phase alternating current (AC) power line RST with the motor controller 221. The motor 110 can instead be a different type of motor, such as any type of direct current (DC) motor (such as an electric brushless motor) or a one-phase AC motor. The motor 110 can drive a (thrust-generating) propeller or a (lift-generating) rotor. The motor 110 can function as a generator. The motor 110 or other electrical powering system of the aircraft 100 can include multiple motors, such as electric motors, as described further herein.

The motor controller 221 can, for example, be connected over a two phase or DC power line with the power source 130 or connected over a three-phase power line with the motor 110. The motor controller 221 can transform, convert, or control the power received from the power source 130 into motor driving signals for driving the motor 110. The motor controller 221 can include a power converter for converting DC current of the power source 130 into a (three phase) (AC) current for the motor 110 (with the power converter working as an inverter). The power converter can treat different input DC voltages (if the power source 130 has multiple battery packs with different DC voltages). If the motor 110 acts as generator, the power controller can convert the current generated from each phase of the motor 110 into a DC current for loading the power source 130 (with the power converter working as a rectifier). The motor controller 221 can generate the motor driving signals for the motor 110 responsive to a user input, for example, with a throttle.

The motor controller 221 can include a control circuit and a power stage controlled by the control circuit. The control circuit of a main motor controller can include a processor, such as a digital signal processor or a field-programmable gate array (FPGA), and a memory device for storing for execution a control program, such as a regulation program in order to regulate a speed and torque of the motor 110 according to one or more parameters measured with a sensor, such as a sensor 115 of FIG. 2 which can be or include an encoder, Hall sensors, or the like. The control circuit of the redundant motor controller can be sensorless and may not include any processor or FPGA for regulating the speed and torque of the motor 110.

The power stage can include power electronic components, such as IGBTs, metal-oxide-semiconductor field-effect transistors (MOSFETs), H bridges, or electromagnetic compatibility (EMC) filters, in order to generate the drive currents for sending to coils of the motor 110 to control the motor 110. The power stage can include silicon carbide components.

The motor controller 221 can include a main motor controller 222A and a redundant motor controller 222B. Moreover, the motor controller 221 can include one controller for powering the motor 110 from a first battery pack and another controller for powering the motor 110 from another battery pack.

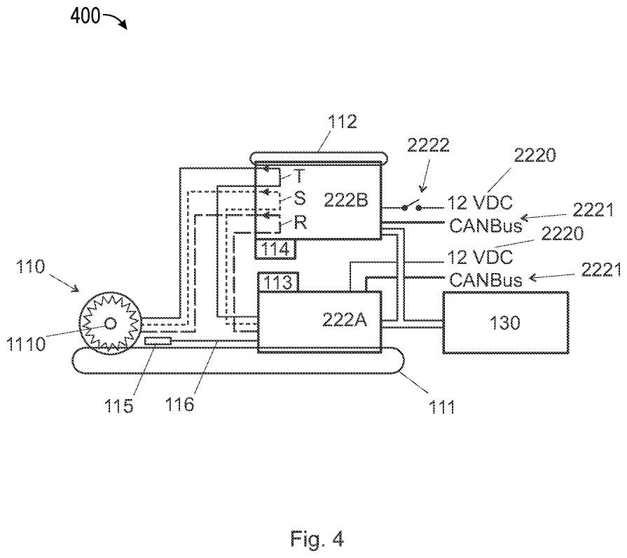

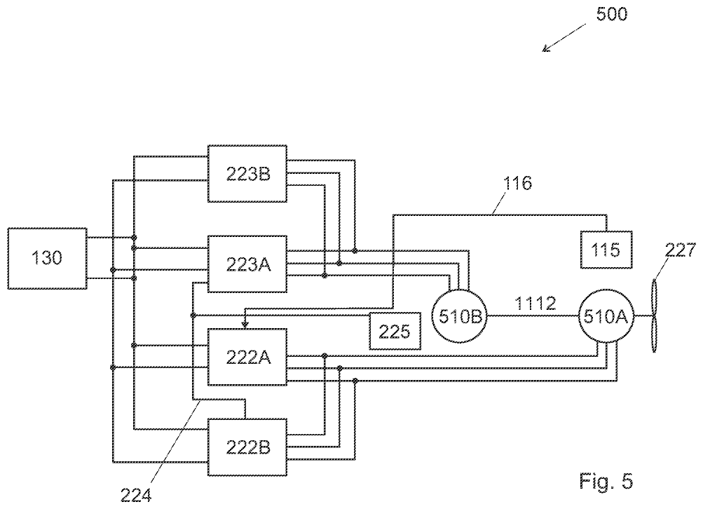

The main motor controller 222A can be a sensored motor controller and use an output from the sensor 115 to determine the position or speed of a rotor of the motor 110, such as a rotor 1110 illustrated in FIGS. 4 and 5. The main motor controller 222A can determine and compare the speed or position of the rotor 1110 to a set speed, position, or torque that the main motor controller 222A may be trying to achieve. Any discrepancies may then be adjusted as part of a closed loop system.

The main motor controller 222A can generate three sinusoidal drive signals with one drive signal being applied to each phase of the motor 110. A sinusoidal signal can refer to a signal which has substantially a sinusoidal waveform when the motor 110 is controlled at constant speed.

The redundant motor controller 222B can be sensorless and thus may not include any sensor, such as the sensor 115, for determining the position or speed of the rotor 1110. The redundant motor controller 222B can control the motor 110 in a closed loop system. The redundant motor controller 222B can use back EMF of the motor 110 (which can be the voltage generated by the motor 110 acting as a generator) or of another motor on the same rotor shaft to determine its speed or position and control the motor 110 in a closed loop system.

The redundant motor controller 222B can generate three drive signals; at each time, two of the three drive signals can be applied to two of the three-phases of the motor 110 while a third phase may be open so that no signal is applied to the third phase. An electromotive signal induced in the third phase by a rotation of the rotor 1110 can be measured in order to determine its speed or position and to control the generation of the two signals.

The redundant motor controller 222B can generate non-sinusoidal drive signals, such as trapezoidal signals or stepped signals, that can be applied to at least two phases of the motor 110. Generating non-sinusoidal signals may not utilize any mathematical prediction of a future position of the rotor 1110 so that the redundant motor controller 222B may not rely on software methods or complex hardware (which may be failure-prone relative to non-software methods) for generating the drive currents, making components or an entirety of the aircraft 100 more robust and easier to certify.

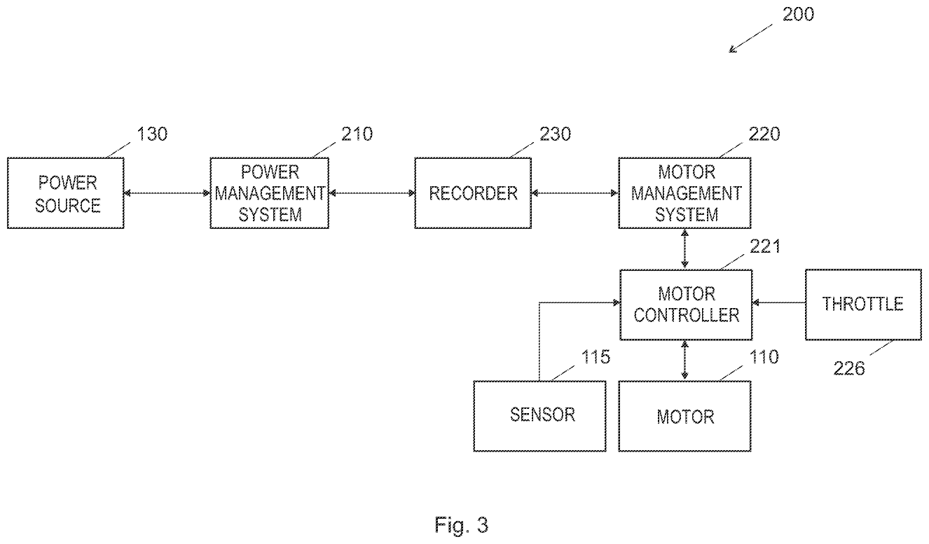

FIG. 3 illustrates components 200 usable for operating an aircraft, such as the aircraft 100 of FIGS. 1 and 2. The components 200 can include a power management system 210, a motor management system 220, a recorder 230, and a throttle 226, as well as the power source 130, the motor controller 221, and the motor 110 of FIG. 2.

The power management system 210, the motor management system 220, and the recorder 230 can monitor communications on a communication bus, such as a controller area network (CAN) bus or analog lines, and communicate via the communication bus. The power source 130 can, for instance, communicate on the communication bus enabling the power management system 210 to monitor and control the power source 130. Features around construction and operation of the power management system 210 are described in greater detail in U.S. Pat. No. 10,131,246, issued Nov. 20, 2018, titled “COMMUNICATION SYSTEM FOR BATTERY MANAGEMENT SYSTEMS IN ELECTRIC OR HYBRID VEHICLES,” which is incorporated herein by reference. As another example, the motor controller 221 can communicate on the communication bus enabling the motor management system 220 to monitor and control the motor controller 221. One of multiple controllers of the motor controller 221, such as the main motor controller 222A, may use the communication bus while another motor controller of multiple controllers of the motor controller 221, such as the redundant motor controller 222B, may use a communication system, which may include analog lines and not include a communication bus, that may be easier to certify.

The recorder 230 can store some or all data communicated (such as component status, temperature, or over/undervoltage information from the components or sensors) on the communication bus to a memory device for later reference, such as for reference by the power management system 210 or the motor management system 220 or for use in troubleshooting or debugging by a maintenance worker. The power management system 210 and the motor management system 220 can each output or include a user interface that presents status information and permits system configuration. The power management system 210 can control a charging process (for instance, a charge timing, current level, or voltage level) for the aircraft 100 when the aircraft 100 may be coupled to an external power source to charge the power source 130.

The motor management system 220 can provide control commands to the motor controller 221, which can in turn be used to operate the motor 110. The motor controller 221 may operate according to instructions from the throttle 226 that may be controlled by a pilot of the aircraft 100.

The power management system 210 and the motor management system 220 may include the same or similar computer hardware. A single hardware may perform both functions.

### System Architecture

Certification requirements can be related to a safety risk analysis. A condition that may occur with an aircraft or its components can be assigned to one of multiple safety risk assessments, which may in turn be associated with a particular certification standard. The condition can, for example, be catastrophic, hazardous, major, minor, or no safety effect. A catastrophic condition may be one that likely results in multiple fatalities or loss of the aircraft. A hazardous condition may reduce the capability of the aircraft or the operator ability to cope with adverse conditions to the extent that there would be a large reduction in safety margin or functional capability crew physical distress/excessive workload such that operators cannot be relied upon to perform required tasks accurately or completely or serious or fatal injury to small number of occupants of aircraft (except operators) or fatal injury to ground personnel or general public. A major condition can reduce the capability of the aircraft or the operators to cope with adverse operating condition to the extent that there would be a significant reduction in safety margin or functional capability, significant increase in operator workload, conditions impairing operator efficiency or creating significant discomfort physical distress to occupants of aircraft (except operator), which can include injuries, major occupational illness, major environmental damage, or major property damage. A minor condition may not significantly reduce system safety such that actions required by operators are well within their capabilities and may include a slight reduction in safety margin or functional capabilities, slight increase in workload such as routine flight plan changes, some physical discomfort to occupants or aircraft (except operators), minor occupational illness, minor environmental damage, or minor property damage. A no safety effect condition may be one that has no effect on safety.

An aircraft can be designed so that different subsystems of the aircraft are constructed to have a robustness corresponding to their responsibilities and any related certification standards, as well as potentially any subsystem redundancies.

Damages to the motor controller 221 can be very serious incidents that may prevent the motor 110 or one or more other motors of the aircraft 100 from working properly, and cause a crash. Therefore, a motor control system can be critical for the safety of aircraft, such as electrically-driven airplanes.

The motor controller 221 may have failings in rare occurrences that cause problems with the ability of the motor controller 221 to drive the motor 110 or monitoring one or more parameters of the motor controller 221. For example, power semiconductors used in inverters may be damaged by overcurrent, overvoltage, overheating, or chocks. In other occurrences, hardware or software modules used for monitoring one or more motor parameters may fail to work properly or to deliver accurate parameters, so the motor may not be controlled correctly or failures of the motor 110 or of the motor controller 221 may not be detected or reported.

The present disclosure provides at least approaches to increase the reliability of the motor controller 221 in the aircraft 100. In order to prevent risks of an incident due to a failure of the motor controller 221, control of the motor 110 can be performed with the main motor controller 222A and redundantly performed with the redundant motor controller 222B. The main motor controller 222A and the redundant motor controller 222B can be different types of controllers to increase a chance that at least one of the main motor controller 222A or the redundant motor controller 222B is properly functioning to operate the motor 110.

As an example and as illustrated by a drive system 400 shown in FIG. 4, the main motor controller 222A and the redundant motor controller 222B can be used for redundantly controlling the motor 110, so even if the main motor controller 222A or the redundant motor controller 222B experiences a failure or fault that impacts an ability to successfully or safely control the motor 110, the motor 110 can still be controlled with one of the main motor controller 222A or the redundant motor controller 222B, at least to insure low speed or low power operation.

The main motor controller 222A and the redundant motor controller 222B can be supported by an aircraft housing.

Each of the main motor controller 222A and the redundant motor controller 222B can include solid-state power electronics components for converting DC current from the power source 130 into AC currents, such as for example tri-phase currents R, S, T, required for driving the motor 110. The main motor controller 222A can include silicon carbide components, which may be less conventionally used components. The redundant motor controller 222B can include more conventional components, such as for example IGBTs.

Each of the main motor controller 222A and the redundant motor controller 222B can include one or more power inverters for controlling the speed or torque of the motor 110 by varying motor input frequency, current, or voltage.

The power inverters can be implemented, for example, as simple inverters, multilevel inverters, or power inverter devices and potentially with an impedance adjustment using an additional amplifier stage, or any combination between those solutions.

The main motor controller 222A can include hardware or software modules for monitoring the power inverters and the other components of the motor controller 221. Those parameters can be used for controlling the power inverters in real time, for example as input of a feedback loop.

If the main motor controller 222A and the redundant motor controller 222B are of the same type, a defect, a conception flaw, or an external event that affects one may also affect the other, so that a gain in reliability may be limited. Therefore, in certain embodiments, in order to increase the reliability of the motor controller 221, the main motor controller 222A is of a different controller type from the redundant motor controller 222B.

More complex systems can generally be more likely to have defects; therefore, a complex motor controller that includes many different components, such as one or more external sensors (such as the sensor 115) and one or more cables (such as a cable 116 of FIGS. 4 and 5) between those sensors and other components of the complex motor controller, may be more prone to defects than a simpler motor controller. Such a complex motor controller may also be more difficult to certify. On the other hand, such a simple motor controller may not offer all of the functionalities of such a complex motor controller, or may not be able to drive a motor at full speed or full torque.

Therefore, in order to increase the reliability of the functioning of the motor controller 221, one of the main motor controller 222A or the redundant motor controller 222B can be more complex than the other. For example, the main motor controller 222A may be more complex than the redundant motor controller 222B.

The main motor controller 222A may control the motor 110 with a relatively large number of components in order to provide a broad set of functionalities to control the motor at full speed or full torque and with a relatively high efficiency or according to additional parameters.

The redundant motor controller 222B may have a relatively simple design and be robust and thus may be able to satisfy difficult certification standards. The redundant motor controller 222B, for instance, can be composed of a relatively small number of components to reduce a number of individual components and cables (which can be referred to as interconnections) to certify.

A failure of the main motor controller 222A may not be catastrophic for the aircraft 100 because the redundant motor controller 222B can be used as a backup. Therefore, even if the main motor controller 222A may include a large set of components, the certification of the main motor controller 222A can be made less stringent because a failure of the main motor controller 222A can be unlikely to have a catastrophic impact as the functionality of the main motor controller 222A can be easily and immediately replaced by the redundant motor controller 222B.

According to one aspect, the main motor controller 222A can have a more complex structure than the redundant motor controller 222B, which may be used to redundantly drive the motor 110. In one example, the main motor controller 222A can include and use the sensor 115, such as a speed or position sensor (encoder), heat sensors, or current sensors, for monitoring one or more parameters of the motor 110. The sensor 115 can be an external hardware sensor. The redundant motor controller 222B may be sensorless and not include any external hardware sensors for controlling its operations.

In one embodiment, the redundant motor controller 222B can include a motor temperature sensor or a motor controller temperature sensor but may nevertheless be considered to be sensorless because the redundant motor controller 222B may not include or use any position or speed sensor. The temperature sensor can be used for reducing an intensity of the currents delivered to the motor 110 when a temperature of the motor 110 or a temperature of the redundant motor controller 222B exceeds a threshold.

In another embodiment, the redundant motor controller 222B may not include any position, speed, temperature or other sensor.

In one example, the main motor controller 222A can include hardware or software modules for monitoring the speed or position of the motor 110 or other parameters of the motors 110 or of the main motor controller 222A itself for controlling currents applied to each coil of the motor 110 in order to achieve a desired rotation speed or torque. The hardware modules can include the sensor 115, which may, for example, be a speed or position sensor for monitoring a rotation speed or position of the rotor, and optionally one or more additional sensors, such as temperature sensors, current sensors, or the like.

The main motor controller 222A can use a closed-loop vector control method to generate three sinusoidal signals dependent on one or more parameters measured with the sensor 115, one signal being applied to each phase of the motor 110. The closed-loop vector control method can allow the motor 110 to be operated efficiently and with low losses. Moreover, applying sinusoidal signals to the phases of the motor 110 can allow for a high efficiency mode of operation of the motor 110. The high efficiency mode of operation, however, may utilize a more complex controller system, such as for example a fast processor or DSP, in order to generate the signals, and may therefore be more failure-prone and more difficult to certify than a less complex controller system.

The redundant motor controller 222B may be sensorless. The redundant motor controller 222B can control the motor 110 in an open-loop system (for instance, without any feedback about a current speed or position of the motor 110). Alternatively, the redundant motor controller 222B can detect a speed and position of the rotor 1110, for example, by measuring and analyzing the back EMF generated in coils of the motor 110 when the rotor 1110 may be rotating. For example, the redundant motor controller 222B can detect zero crossings of the back EMF signal to determine the rotation speed of the rotor 1110, as well as by interpolating or integrating an angular position of the rotor 1110. In one embodiment, the redundant motor controller 222B can generate three drive signals, two of which may be applied at each time to phase coils of the motor 110. The zero-crossing of the electromotive signal induced in a third phase by the rotation of the rotor 1110 may be measured to determine a speed or position of the rotor 1110 and to control the generation of the two drive signals in a closed-loop, sensorless system.

Because the redundant motor controller 222B may include fewer components than the main motor controller 222A and fewer or no hardware sensors for monitoring speed and position parameters of the motor 110, the main motor controller 222A and aircraft 100 can be easier to certify and have an increased reliability. For example, because the redundant motor controller 222B may be sensorless, the redundant motor controller 222B can be composed of simple, easy-to-certify, and reliable components.

Because the redundant motor controller 222B may not include any sensors, the redundant motor controller 222B can determine the speed and position of the rotor 1110 when a back EMF signal is generated, for example in the third phase. The redundant motor controller 222B may not, in some implementations, however, not determine the speed or position of the rotor 1110 using another approach. This may make control of the motor 110 at 0 revolutions per minute (RPM) difficult, but because the redundant motor controller 222B may be used as a backup in flight when the main motor controller 222A has a failure, this difficulty may be a minor condition and not a major condition, a hazardous condition, or a catastrophic condition. Moreover, because a start torque requested for starting the rotation of the rotor 1110 and its associated propeller may be low as compared to a start torque in an electric car, for example, the redundant motor controller 222B can be used for starting turning of the rotor 1110 from 0 RPM.

The redundant motor controller 222B can generate a set of two or three non-sinusoidal drive signals R, S, T that may be applied to phases of the motor 110. For example, the redundant motor controller 222B can generate two or three trapezoid signals or stepped signals. The generation of trapezoidal or stepped signals can be performed without any interpolation or complex mathematical predictions and may therefore be relatively easier to certify than an approach where signal generation is performed with interpolation or complex mathematical predictions.

FIG. 5 illustrates another embodiment of a drive system 500 for the aircraft 100. The drive system 500 can include a first transducer 510A and a second transducer 510B in place of the motor 110. The first transducer 510A can be controlled by the main motor controller 222A or the redundant motor controller 222B, as previously described. The second transducer 510B can be controlled by another main motor controller 223A or another redundant motor controller 223B, for example, when the another main motor controller 223A has a failure.

The first transducer 510A can selectively operate as a motor or a generator for charging the power source 130, for example at landing. The second transducer 510B can selectively operate as a generator for charging the power source 130, for example at landing, or a motor for assisting the first transducer 510A when additional power may be desired, for example at take-off, or for replacing the first transducer 510A in the event of a failure of the first transducer 510A. Features around construction and operation of multiple transducers are described in greater detail in U.S. Pat. No. 10,322,824, issued Jun. 18, 2019, titled “CONSTRUCTION AND OPERATION OF ELECTRIC OR HYBRID AIRCRAFT,” which is incorporated herein by reference.

Each of the first transducer 510A and the second transducer 510B can have a rotor. The two rotors of the first transducer 510A and the second transducer 510B can be mechanically attached to a rotor shaft 1112 so that an angular position of the two rotors the first transducer 510A and the second transducer 510B may be related.

At some instants, the first transducer 510A can be used as a motor for propelling the aircraft 100, such as with a propeller 227, while the second transducer 510B is either freewheeling or used as a generator, for example in order to charge a power source or equilibrate charges between different power sources. The EMF induced in the second transducer 510B can be measured by a circuit 225 that may generate a signal communicated via lines 224. The signal can be used by the redundant motor controller 222B for generating drive signals that are applied to the first transducer 510A for controlling a position or a speed of the first transducer 510A.

The main motor controller 222A can include and use more complex software modules or algorithms to control the motor 110 than the redundant motor controller 222B. For example, the main motor controller 222A can perform a more complex regulation, based on feedback signals provided by the sensor 115, than the redundant motor controller 222B that may instead perform a simple regulation without use of a speed or a position of the motor 110 measured with any sensor.

The main motor controller 222A and the redundant motor controller 222B can exchange information in real time, such as with or through the motor management system 220 of FIG. 2 in order to control the motor 110 in the desired way, and to send parameters and diagnosis, including parameters measured by the sensor 115, to the motor management system 220.

The redundant motor controller 222B can redundantly control the motor 110 and redundantly transmit parameters measured on the motor 110.

The main motor controller 222A may be used to drive the motor 110 at full speed or full torque. The redundant motor controller 222B may be used to drive the motor 110 up to a lower speed or a lower torque than the main motor controller 222A. For example, the redundant motor controller 222B can deliver a maximal power (such as for example 65 KW) to drive the motor 110 at a maximum speed (such as for example RPM) and torque usable for continuous or cruisier flight of the aircraft 100, but that may not be sufficient for take-off of the aircraft 100. The main motor controller 222A may deliver a higher maximal power (for example 90 KW) than the redundant motor controller 222B.

Because the main motor controller 222A can control the motor 110 at a higher speed or a higher torque than the redundant motor controller 222B, and because the main motor controller 222A may be commuted more often than the redundant motor controller 222B, the main motor controller 222A may dissipate more heat in its power semiconductors than the redundant motor controller 222B. In one aspect, the main motor controller 222A can include or be associated with a first heat dissipating system 111, such as for example a liquid-based cooling system, that may be used for cooling the main motor controller 222A and may be more efficient than a second heat dissipating system 112, such as for example an air-based cooling system, which can be included in or associated with the redundant motor controller 222B and used for cooling the redundant motor controller 222B.

The first heat dissipating system 111 can be a different cooling system or a different type of cooling system than the second heat dissipating system 112. Because two different cooling systems or two different types of cooling systems may be used, the cooling of the main motor controller 222A and the redundant motor controller 222B can be more reliable than if the main motor controller 222A and the redundant motor controller 222B shared a single cooling system or a single type of cooling system. Moreover, a defect, design flaw, or an external event that may impact one of the first heat dissipating system 111 or the second heat dissipating system 112 may be less likely to impact the other of the first heat dissipating system 111 or the second heat dissipating system 112.

The redundant motor controller 222B can weigh less than or have a smaller volume than the main motor controller 222A, such as due to redundant motor controller 222B including fewer components, being capable of providing less power to the motor 110, and having more limited functionalities. The redundant motor controller 222B can be constructed to operate in a broad range of temperature or radiation environments because the redundant motor controller 222B may include less components. As a result, the addition of the redundant motor controller 222B may have a limited impact on a weight, volume, operability, or range of the aircraft 100.

In one embodiment, the main motor controller 222A and the redundant motor controller 222B can share a common electronic power stage, including for example common IGBTs, MOSFETs, H bridges, or EMC filters. The main motor controller 222A and the redundant motor controller 222B may, however, include or use two different control circuits for controlling common electronic power stage. The control circuit for the main motor controller 222A may use a more complex or sophisticated software and rely on one or more external sensors for controlling a speed and a torque of the motor 110, while the control circuit for the redundant motor controller 222B may use a simpler regulation, with a simpler software or no software, and not rely on external sensors for controlling the motor 110.

A switch 2222 can activate the redundant motor controller 222B to control the motor 110 in place of the main motor controller 222A, such as in case of a failure of the main motor controller 222A. The switch 2222 can be operated by a pilot of the aircraft 100 or automatically triggered responsive to a determined condition. The switch 2222 may, for example, cause the redundant motor controller 222B to be powered, the motor 110 to be disconnected from the main motor controller 222A, the redundant motor controller 222B to be connected with the motor 110, or the power source 130 to be disconnected from the main motor controller 222A.

A first motor controller monitoring system 113 can detect failures of the main motor controller 222A. A second motor controller monitoring system 114 can also detect failures of the main motor controller 222A. The second motor controller monitoring system 114 can be redundant to the first motor controller monitoring system 113 and of a different type than the first motor controller monitoring system 113. The first motor controller monitoring system 113 can use programmable components and provide more functionalities than the second motor controller monitoring system 114, which may use include non-programmable components but not programmable-components. The second motor controller monitoring system 114 can thus offer fewer functionalities but may be easier to certify than the first motor controller monitoring system 113.

The first motor controller monitoring system 113 can be separate from the second motor controller monitoring system 114.

The detection of a failure of the main motor controller 222A by the first motor controller monitoring system 113 can trigger an automatic and potentially immediate transition from the main motor controller 222A controlling the motor 110 to the redundant motor controller 222B controlling the motor 110.

The main motor controller 222A or the redundant motor controller 222B can be connected by a communication bus, such as a CAN bus 2221 shown in FIG. 5. The CAN bus 2221 can permit digital communication between components, such as the main motor controller 222A and the redundant motor controller 222B. The CAN bus 2221 can be used for diagnostic purposes of the main motor controller 222A and for controlling the main motor controller 222A according to signals sent over the CAN bus 2221 by the motor management system 2220 or the throttle 226. The throttle 226 may, in some implementations, provide signals to control the main motor controller 222A and the redundant motor controller 222B via one or more lines that are independent of the CAN bus 2221. The CAN bus 2221 can be used for diagnostic purposes of the redundant motor controller 222B. The redundant motor controller 222B may not be controlled over the CAN bus 2221, in order to simplify the certification of the redundant motor controller 222B and the CAN bus 2221.

### Additional Features and Terminology

Although examples provided herein may be described in the context of an aircraft, such as an electric or hybrid aircraft, one or more features may further apply to other types of vehicles usable to transport passengers or goods. For example, the one or more futures can be used to enhance construction or operation of automobiles, trucks, boats, submarines, spacecrafts, hovercrafts, or the like.

As used herein, the term “sensorless,” in addition to having its ordinary meaning, can refer to a component or system or device that can measure a physical parameter without any additional, external sensors. For example, any motor controller that can determine the speed or the position of a rotor from EMC currents generated in the coils of the motors, without any independent or separate speed or position sensor, may be said to be sensorless. A motor controller can also said to be sensorless if the closed-loop control system used for regulating the speed of the rotor does not rely on any external hardware sensors, such as Hall sensors. A motor controller may be considered to be sensorless even if it includes or uses sensors for determining parameters other than the speed or the position of the rotor; for example, a motor controller including or using a temperature sensor may be considered to be sensorless.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for instance, through multi-threaded processing, interrupt processing, or multiple processors or processor cores or on other parallel architectures, rather than sequentially. In addition, different tasks or processes can be performed by different machines or computing systems that can function together.

The various illustrative logical blocks, modules, and algorithm steps described herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, a microprocessor, a state machine, a digital signal processor (DSP), an application specific integrated circuit (ASIC), a FPGA, or other programmable logic device, discrete gate or transistor logic, discrete hardware components, or any combination thereof designed to perform the functions described herein. A hardware processor can include electrical circuitry or digital logic circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

The steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements or states. Thus, such conditional language is not generally intended to imply that features, elements or states are in any way required for one or more embodiments or that one or more embodiments necessarily include logic for deciding, with or without author input or prompting, whether these features, elements or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

1. A drive system for an electrically-driven aircraft, the drive system comprising:
a first motor controller configured to control a motor to propel a vehicle housing, the first motor controller being configured to control the motor using a parameter measured with a sensor configured to monitor a motor system component; and
a second motor controller configured to provide redundant control of the motor to propel the vehicle housing, the second motor controller being configured to control the motor without using a physical position of any motor system component measured with any sensor and without using a change in the physical position of any motor system component measured with any sensor.

2. The drive system of claim 1, wherein the motor system component comprises a rotor of the motor, and the sensor comprises an encoder, the parameter comprising the physical position of the rotor or the change in the physical position of the rotor.

3. The drive system of claim 1, wherein the second motor controller comprises fewer components than the first motor controller.

4. The drive system of claim 1, wherein the second motor controller weighs less than the first motor controller, and the second motor controller has a smaller volume than the first motor controller.

5. The drive system of claim 1, wherein the first motor controller is configured to control the motor to operate at a higher maximal rotation speed the second motor controller.

6. The drive system of claim 1, wherein the first motor controller is configured to control the motor to operate at a higher maximal torque than the second motor controller.

7. The drive system of claim 1, wherein the motor comprises a three-phase electric motor.

8. The drive system of claim 7, wherein the motor comprises a permanent magnet synchronous motor.

9. The drive system of claim 7, wherein the first motor controller is configured to generate three sinusoidal signals from the parameter to control the motor using a closed-loop vector control.

10. The drive system of claim 7, wherein the second motor controller is configured to generate a plurality of non-sinusoidal signals to control the motor.

11. The drive system of claim 7, wherein the second motor controller is configured to generate a plurality of stepped signals to control the motor.

12. The drive system of claim 1, further comprising a switch configured to receive a user input to cause the second motor controller to control the motor in place of the first motor controller.

13. The drive system of claim 12, wherein the switch is configured to connect the motor either to the first motor controller or the second motor controller.

14. The drive system of claim 12, wherein the switch is configured to connect a power source either to the first motor controller or the second motor controller.

15. The drive system of claim 1, further comprising a first motor controller monitoring system configured to detect a failure of the first motor controller and, responsive to detecting the failure, cause the second motor controller to control the motor in place of the first motor controller, the first motor controller monitoring system being separate from the second motor controller.

16. The drive system of claim 15, further comprising a second motor controller monitoring system configured to detect the failure of the first motor controller and, responsive to detecting the failure, cause the second motor controller to control the motor in place of the first motor controller, the first motor controller monitoring system comprising programmable components and the second motor controller monitoring system consisting of non-programmable components.

17. The drive system of claim 1, wherein the first motor controller comprises silicon carbide components and a digital signal processor.

18. The drive system of claim 17, wherein the second motor controller comprises insulated-gate bipolar transistor components.

19. The drive system of claim 1, further comprising:
a first cooling system configured to dissipate heat produced by the first motor controller; and
a second cooling system configured to dissipate heat produced by the second motor controller, the second cooling system being of a different type of cooling system than the first cooling system.

20. The drive system of claim 19, wherein the first cooling system is a liquid-based cooling system, and the second cooling system is an air-based cooling system.

21. The drive system of claim 1, wherein the motor comprises a first rotor, and the second motor controller is configured to use an electromotive force induced in a transducer to control the motor, the transducer comprising a second rotor that is mechanically attached to a rotor shaft, the rotor shaft being mechanically attached to the first rotor.

22. The drive system of claim 1, in combination with the motor, the vehicle housing, and the sensor, the vehicle housing being configured to fly.

23. A method for operating an electrically-driven aircraft, the method comprising:
measuring a parameter with a sensor that is monitoring a motor system component;
by a first motor controller, controlling, using the parameter, a motor to propel a vehicle housing; and
by a second motor controller, controlling, without using a physical position of any motor system component measured with any sensor and without using a change in the physical position of any motor system component measured with any sensor, the motor to propel the vehicle housing when the first motor controller is not controlling the motor to propel the vehicle housing.

24. The method of claim 23, wherein the motor system component comprises a rotor of the motor, and the sensor comprises an encoder, the parameter comprising the physical position of the rotor or the change in the physical position of the rotor.

25. The method of claim 23, further comprising:
receiving a user input with a switch; and
in response to receiving the user input, causing the second motor controller to control the motor in place of the first motor controller.

26. The method of claim 23, further comprising:
detecting a failure of the first motor controller; and
in response to detecting the failure, causing the second motor controller to control the motor in place of the first motor controller.
